(19) United States
(12) Patent Application Publication
(10) Pub. No.: US 2004/0142592 A1
(43) Pub. Date: Jul. 22, 2004

(54) Insulation displacement connector and manufacturing method thereof

(76) Inventor: Yuan-Huei Peng, Taipei (TW)

Correspondence Address: SILICON VALLEY PATENT GROUP LLP, 2350 MISSION COLLEGE BOULEVARD, SUITE 360, SANTA CLARA, CA, 95054, US

(21) Appl. No.: 10/632,469

(22) Filed: Aug. 1, 2003

(30) Foreign Application Priority Data
Jan. 16, 2003 (TW) 092100925

(51) Int. Cl. H01R 4/24

(52) U.S. Cl. 439/409

(57) ABSTRACT

The present invention discloses an insulation displacement connector (IDC) and the manufacturing method thereof. The manufacturing method of an insulation displacement connector for a conducting wire, including steps of providing a main body, setting a terminal/plural terminals disposed in the main body, providing a pivotable cover on the main body, placing a conducting wire between the terminal and the pivotable cover and pivoting the pivotable cover against the main body, thereby the terminal piercing into the conducting wire and electrically connecting therewith.

### FIELD OF THE INVENTION

The present invention relates to a communication connector, and more particularly, to an insulation displacement connector (IDC) and the manufacturing method thereof.

### BACKGROUND OF THE INVENTION

Most regular insulation displacement connectors (IDC) use multiple insulation displacement terminals to connect the conducting wires and the insulation displacement terminals are all fixedly mounted in the terminal seat. The seat can be either vertical or horizontal to the Printed Circuit Board (PCB). And it is usually connected with a plug through a Keystone Jack when the plug is plugged into. Please refer to FIGS. 1-2. FIG. 1 is a schematical view illustrating the assembling process of the wire pincer, double-rowed terminal seats and the printed circuit board according to the prior art. It reveals two terminal seats 10, eight insulation displacement terminals 11 and a Printed Circuit Board (PCB) 12. The terminal seats 10 can be soldered to the Printed Circuit Board (PCB) 12 for electrical connection. FIG. 2 is a schematical view illustrating the assembling process of a double-rowed keystone terminal seats, a keystone jack and a printed circuit board according to the prior art. Two terminal seats 20 can be placed in the Keystone Jack 24. The eight insulation displacement terminals 26 are positioned in the terminal seats 20 and all are vertical to the Printed Circuit Board (PCB) 25. The user can first put four of the eight conducting wires 22 into four of the eight terminals 26 by using the wire pincer 13 (as shown in FIG. 1) without any tools. Then, the user can put the other four conducting wires 22 into the other four terminals 26 by another wire pincer 13.

Although there is no need to use a hammer-like tool for pressing the conducting wires 22 in, it still takes lots of exertion to do it without helping tools. Besides, the width of wire pincer is only 7 mm. That tires the users' fingers easily. Please refer to FIG. 2, the terminal seat 20 is fixedly positioned by the locating plate 21 which is independent of the terminal seat 20. In other words, they are separately made by different molds.

From the above description, it is known that how to improve the way to connect the terminals and the conducting wires of the traditional insulation displacement connector (IDC) has become a major problem waited to be solved. After continuously researching, the inventor finally comes out the new insulation displacement connector (IDC) and the manufacturing method thereof to effectively solve the disadvantages of the prior art and speed up the displacement of insulation displacement connector (IDC).

Therefore, the present invention provides a manufacturing method of the insulation displacement connector which overcomes the disadvantages described above. Thus, the present invention has the utility for the industry.

### SUMMARY OF THE INVENTION

The main object of the present invention is to provide a pivotable cover on the main body of the insulation displacement connector, which allows a conducting wire between the terminal and the pivotable cover to be pierced by the terminal via pivoting the pivotable cover against the main body so that the terminal and the conducting wire are electrically connected.

It is one object of the present invention to provide a manufacturing method of an insulation displacement connector for a conducting wire, which speeds up the manufacture of the insulation displacement connector.

It is an object of the present invention to provide a manufacturing method of an insulation displacement connector for a conducting wire, including steps of providing a main body, setting a terminal/plural terminals disposed in the main body, providing a pivotable cover on the main body, placing a conducting wire between the terminal and the pivotable cover, and pivoting the pivotable cover against the main body, thereby the terminal piercing into the conducting wire and electrically connecting therewith.

Preferably, the main body further includes a pivot element for pivoting the pivotable cover and the main body.

Preferably, the pivotable cover has a wide surface for applying a pivoting force.

Preferably, the main body further includes a mortise for fastening a tenon on the pivotable cover.

Preferably, the terminal is located in an injection molding device and an injection molding material is injected into the injection molding device to form a terminal seat so that the terminal is simultaneously encapsulated and assembled with the terminal seat.

Preferably, the pivotable cover further includes a concave hollow for containing and covering the terminal seat.

Preferably, the main body further includes a locating plate to fix a position of the terminal seat, and the locating plate and the terminal seat are formed integrally.

Preferably, the pivot element is a lug for serving as a pivoting axis of the pivotable cover and the pivotable cover further includes a lug hole to contain the lug.

Preferably, the pivotable cover has a plurality of wire holes for passing therethrough the conducting wire.

It is an another object of the present invention to provide an insulation displace connector for a conducting wire, including a main body with a pivot element, a terminal disposed in the main body, and a pivotable cover pivotably connected to the main body, wherein when the pivotable cover is pivoted toward the main body, a conducting wire located between said terminal and said pivotable cover is pierced by said terminal and the conducting wire and the terminal are electrically connected to each other thereby.

Preferably, the pivot element is a lug for serving as a pivoting axis of the pivotable cover and the pivotable cover further includes a lug hole to contain the lug.

Preferably, the pivotable cover has a plurality of wire holes for passing therethrough the conducting wire.

Preferably, the terminal is disposed on a terminal seat.

Preferably, the pivotable cover further includes a concave hollow for containing and covering the terminal seat.

Preferably, the connector further includes a locating plate for positioning the terminal seat and the locating plate and the terminal seat are integrally formed.

Preferably, the locating plate includes an extended tenon for fastening an internal mortise of the main body.

Preferably, the locating plate has a curved opening for passing therethrough a cable.

Preferably, the terminal is soldered on a printed circuit board for being electrically connected to a gold-finger.

Preferably, the terminal has a plurality of pin-points for displacing the conducting wire.

Preferably, the connector further includes at least another terminal.

It is an another object of the present invention to provide an insulation displacement connector for a conducting wire, including a main body with a pivot device, a terminal disposed in the main body, and a pivotable device pivotably connected to the main body, wherein when the pivotable device is pivoted toward the main body, a conducting wire located between the terminal and the pivotable device is pierced by the terminal and the conducting wire and the terminal are electrically connected to each other thereby.

Preferably, the pivotable device is a pivotable cover.

### BRIEF DESCRIPTION OF THE DRAWINGS

FIG. 1 is a schematical view illustrating the assembling process of the wire princer, twin-row terminal seat and the printed circuit board according to prior art;

FIG. 2 is a schematical view illustrating the assembling process of a twin-row keystone terminal seat, a keystone jack and a printed circuit board according to prior art;

FIG. 3 is a schematical view illustrating the assembling process of the manufacturing method for the insulation displacement connector according to a preferred embodiment of the present invention;

FIG. 4 is a schematical view illustrating the complete assembly of the insulation displacement terminal seat and the keystone jack according to a preferred embodiment of the present invention;

FIG. 5 is a cross-section schematical view illustrating the pivotable cover according to a preferred embodiment of the present invention;

FIG. 6 is a schematical view illustrating the insulation displacement terminal shown in FIG. 3 according to a preferred embodiment of the present invention;

FIG. 7 is a lateral view showing the rotatable movement of pivotable cover on socket main body according to a preferred embodiment of the present invention;

FIG. 8. is a schematical view illustrating the insulation displacement terminal according to another preferred embodiment of the present invention; and

FIGS. 9 is a schematical view from the bottom side illustrating the insulation displacement connector shown in FIG. 4 according to a preferred embodiment of the present invention.

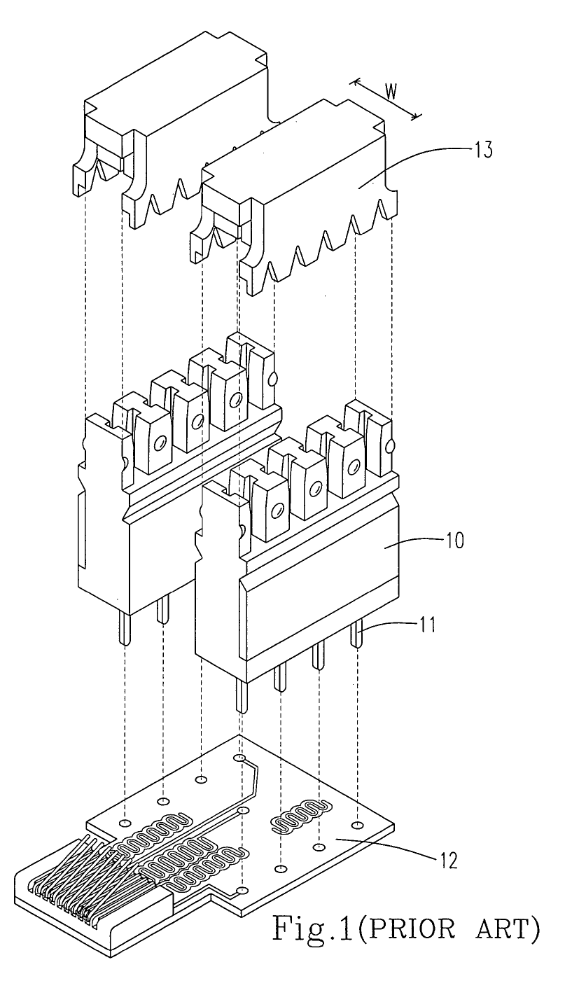

### DETAILED DESCRIPTION OF THE PREFERRED EMBODIMENT

The present invention will now be described more specifically with reference to the following embodiments.

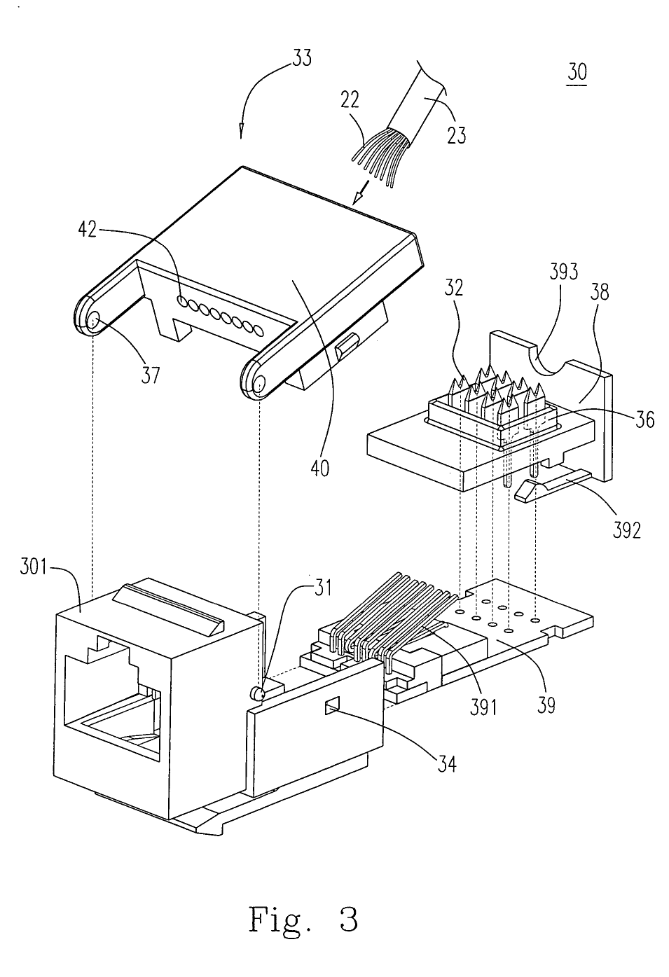

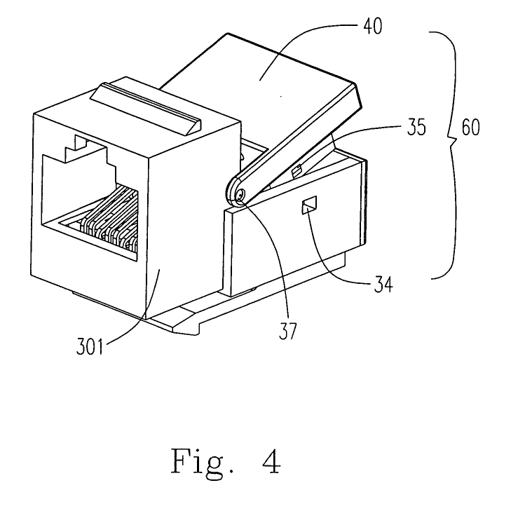

Please refer to FIG. 3 and FIG. 4. FIG. 3 is a schematical view illustrating the assembling process of the manufacturing method for the insulation displacement connector according to a preferred embodiment of the present invention. FIG. 3 shows the manufacturing method for the insulation displacement connector (IDC) 30. First, the socket main body 301 is provided, which includes the pivot element 31, eight terminals 32 and the pivotable cover 33 connected to the pivot element 31. The pivot element 31 can be a lug which serves as a pivoting axis of the pivotable cover 33. And the pivotable cover 33 has the axis hole 37 for connecting with the pivot element 31. The pivotable cover 33 has the wide surface 40. Users can easily press the wide surface downwards and give a particular pressure on the wide surface 40. The terminals 32 of the connector 30 can be soldered to the Printed Circuit Board (PCB) 39. Therefore, they will be electrically connected with the eight gold-fingers 391. The locating plate 38 is to fix the position of the terminal seat 36 and has a curved opening 393 for passing therethrough a cables 23. The locating plate 38 and the terminal seat 36 are integrally formed. The socket main body 301 has a mortise 34 to mortise the tenon 35 on the pivotable cover 33 while the pivotable cover is pivoted toward the main body 301. Please refer to FIG. 4, which is a schematical view illustrating the complete assembly of the insulation displacement terminal seat and the keystone jack according to a preferred embodiment of the present invention. The elements described above are assembled to form an insulation displacement connector 30 as shown in FIG. 4. An user can press the wide surface 40 downwards for pivoting the pivotable cover 33 against the main body 301 when a conducting wire is placed between the pivotable cover 33 and the terminal seat 36, thereby the terminal 32 (as shown in FIG. 3) will pierce into the conducting wire and is electrically connected therewith.

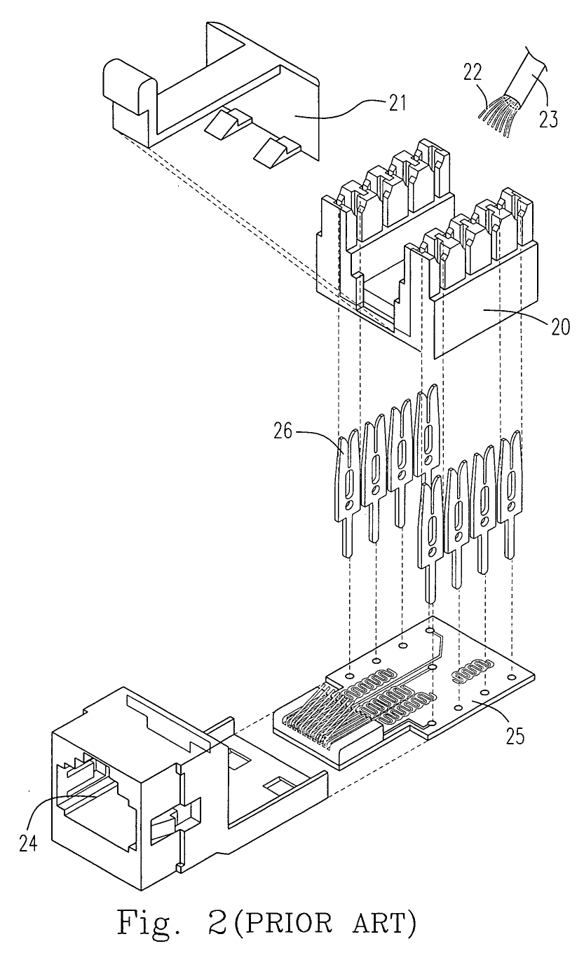

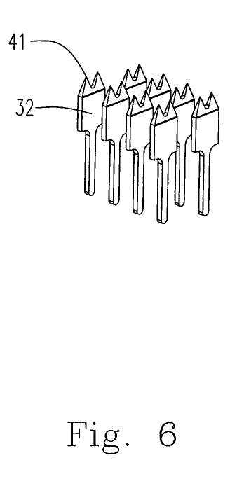

Please refer to FIG. 3 and FIG. 6. FIG. 6 is a schematical view illustrating the insulation displacement terminal shown in FIG. 3 according to a preferred embodiment of the present invention. The two-pin-point part 41 of the terminal 32 is used to pierce into the conducting wire 22 (as shown in FIG. 2). The terminal 32 is placed in an injection-molding device (not shown). The molding materials are injected into the injection-molding device for forming a terminal seat 36 (as shown in FIG. 3). Therefore, the terminal seat 36 and the terminal 32 can be fitly combined together. As shown in FIG. 6, the terminals 32 are arranged in two rows. The arrangement of the terminals 32 can be changed from four terminals per row to three rows. For example, one row includes three terminals, another row includes two terminals and the other row includes three terminals.

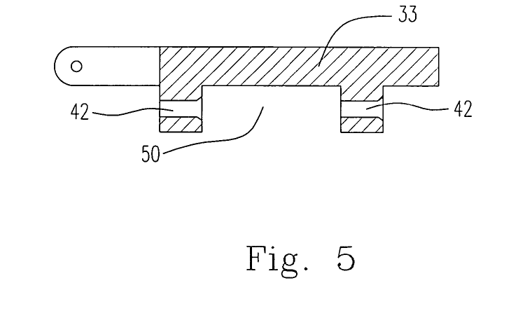

Please refer to FIG. 3 and FIG. 5. According to FIG. 3, two lateral sides of the pivotable cover 33 have eight wire holes 42 respectively. The eight wire holes 42 is used for passing therethrough a conducting wire 22. Please refer to FIG. 5, which is a cross-section schematical view illustrating the pivotable cover according to a preferred embodiment of the present invention. The concave hollow 50 on pivotable cover 33 is able to contain and cover the terminal seat 36. FIG. 5 also shows the cross-section view of the wire hole 42. When eight conducting wires 22 are passed through the eight wire holes 42 (as shown in FIG. 3) of both lateral sides of the pivotable cover 33, the wires are also passed through the concave hollow 50 and positioned between the pivotable cover 33 and the terminal 32.

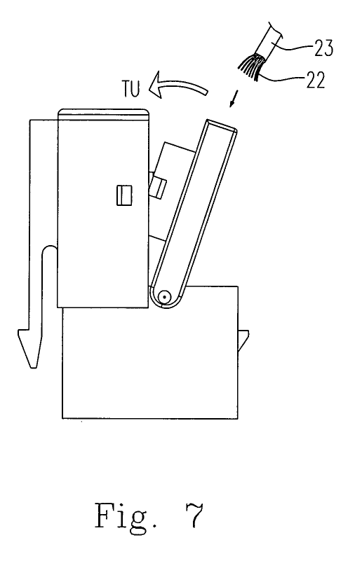

Please refer to FIG. 3 and FIG. 7. FIG. 7 is a side view showing the rotatable movement of pivotable cover on socket main body according to a preferred embodiment of the present invention. The eight conducting wires 22 are passed through the eight wire holes 42 (as shown in FIG. 3) respectively. The rotatable movement (TU) provided by a user will lead to the result that the eight conducting wires 22 will be pierced by the terminals 32 while the eight conducting wires 22 are positioned between the pivotable cover 33 and the terminal 32. And then the conducting wires 22 and terminals 32 will be electrically connected.

In addition, according to another preferred embodiment in the present invention, the insulation displacement connector (IDC) is provided. Please refer to FIG. 3. The insulation displacement connector (IDC) 30 includes the socket main body 301 with the pivot element 31, eight terminals 32 and the pivotable cover 33 pivoted to the pivot element 31. By the rotatable movement TU, the eight conducting wires 22 placed between the pivotable cover 33 and the terminals 32 can be pierced by the terminals 32. And then, the terminals 32 and the conducting wires 22 are electrically connected.

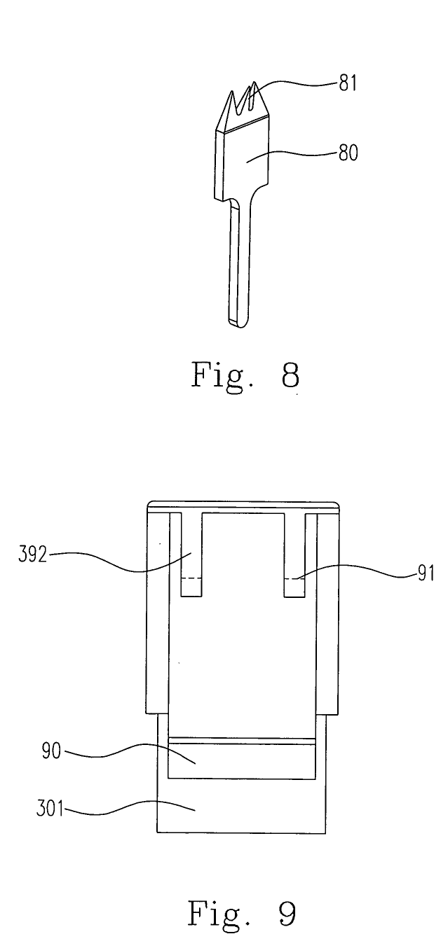

Please refer to FIG. 6 and FIG. 8. FIG. 8. is a schematical view illustrating the insulation displacement terminal according to another preferred embodiment of the present invention. The terminal 32 (as shown in FIG. 6) can be replaced by the terminal 80 (as shown in FIG. 8). The three-pin-point portion 81 is deigned for piercing into the conducting wire 22. Please refer to FIG. 3, the numbers of the terminal 32 and the conducting wire 22 can both be two or more. While the conducting wires 22 are positioned between the pivotable cover 33 and the terminal 32, the conducting wires 22 can be pierced thereinto in sequence by the rotating movement TU of the pivotable cover 33.

Please refer to FIG. 3 and FIG. 9. FIG. 9 is a bottom view illustrating the insulation displacement connector shown in FIG. 4 according to a preferred embodiment of the present invention. The locating plate 38 (as shown in FIG. 3) has an extended tenon 392 used to fasten the internal mortise 91(as shown in FIG. 9) on the socket main body 301. And the hook 90 is provided for fixing the socket main body 301 on a plate (not shown). The locating plate 38 having a curved opening 393 for passing therethrough the cables 23.

In addition, according to another preferred embodiment in the present invention, the insulation displacement connector (IDC) 30 is provided. Please refer to FIG. 3. The IDC 30 includes the socket main body 301 with the pivot element 31, eight terminals 32 and the pivotable device 33 (as the pivotable cover 33 shown in FIG. 3) connected to the pivot element 31. The pivotable device can be modified and not be limited to the pivotable cover 33. By the rotatable movement (TU), the eight conducting wires 22 are pierced by the terminals 32 while they are positioned between the pivotable device 33 and the terminals 32. And the pivotable device 33 of the connector 30 is the pivotable cover 33 to cover the terminal seat 36 of the IDC.

To sum up the above, the present invention truly uses a completely new way which simply pivots the pivotable cover against the socket main body for piercing the conducting wires by the pin-like terminals and achieving the electrical connection. Moreover, by using the pivot element on the socket main body for pivoting the pivotable cover, the manufacturing method speeds up the displacement for the conducting wires placed in the pivotable cover. This is very suitable for the mass production in the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A manufacturing method of an insulation displacement connector for a conducting wire, comprising steps of:
(a) providing a main body;
(b) setting a terminal/plural terminals disposed in said main body;
(c) providing a pivotable cover on said main body;
(d) placing a conducting wire between said terminal and said pivotable cover; and
(e) pivoting said pivotable cover against said main body, thereby said terminal piercing into said conducting wire and electrically connecting therewith.

2. The method as claimed in claim 1, wherein said main body further comprises an pivot element for pivoting said pivotable cover and said main body.

3. The method as claimed in claim 1, wherein said pivotable cover has a wide surface for applying a pivoting force.

4. The method as claimed in claim 1, wherein said main body further comprises a mortise for fastening a tenon on said pivotable cover.

5. The method as claimed in claim 1, wherein said terminal is located in an injection molding device and an injection molding material is injected into said injection molding device to form a terminal seat so that said terminal is simultaneously encapsulated and assembled with said terminal seat.

6. The method as claimed in claim 5, wherein said pivotable cover further comprises a concave hollow for containing and covering said terminal seat.

7. The method as claimed in claim 5, wherein said main body further comprises a locating plate to fix a position of said terminal seat, and said locating plate and said terminal seat are formed integrally.

8. The method as claimed in claim 1, wherein said pivot element is a lug for serving as a pivoting axis of said pivotable cover and said pivotable cover further comprises a lug hole to contain said lug.

9. The method as claimed in claim 1, wherein said pivotable cover has a plurality of wire holes for passing therethrough said conducting wire.

10. An insulation displace connector for a conducting wire, comprising:
a main body with a pivot element;
a terminal disposed in said main body; and
a pivotable cover pivotably connected to said main body, wherein when said pivotable cover is pivoted toward said main body, a conducting wire located between said terminal and said pivotable cover is pierced by said terminal and said conducting wire and said terminal are electrically connected to each other thereby.

11. The connector as claimed in claim 10, wherein said pivot element is a lug for serving as a pivoting axis of said pivotable cover and said pivotable cover further comprises a lug hole to contain said lug.

12. The connector as claimed in claim 10, wherein said pivotable cover has a plurality of wire holes for passing therethrough said conducting wire.

13. The connector as claimed in claim 10, wherein said terminal is disposed on a terminal seat.

14. The connector as claimed in claim 13, wherein said pivotable cover further comprises a concave hollow for containing and covering said terminal seat.

15. The connector as claimed in claim 13 further comprising a locating plate for positioning said terminal seat and said locating plate and said terminal seat are integrally formed.

16. The connector as claimed in claim 15, wherein said locating plate comprises an extended tenon for fastening an internal mortise of said main body.

17. The connector as claimed in claim 15, wherein said locating plate has a curved opening for passing therethrough a cable.

18. The connector as claimed in claim 10, wherein said terminal is soldered on a printed circuit board for being electrically connected to a gold-finger.

19. The connector as claimed in claim 10, wherein said terminal has a plurality of pin-points for displacing said conducting wire.

20. The connector as claimed in claim 10, further comprising at least another said terminal.

21. An insulation displacement connector for a conducting wire, comprising:
a main body with a pivot device;
a terminal disposed in said main body; and
a pivotable device pivotably connected to said main body, wherein when said pivotable device is pivoted toward said main body, a conducting wire located between said terminal and said pivotable device is pierced by said terminal and said conducting wire and said terminal are electrically connected to each other thereby.

22. The connector as claimed in claim 21, wherein said pivotable device is a pivotable cover.
